(19) United States
(12) Patent Application Publication
(10) Pub. No.: US 2001/0050636 A1
(43) Pub. Date: Dec. 13, 2001

(54) Antenna for radio-operated communication terminal equipment

(76) Inventor: Martin Weinberger, Muenchen (DE)

Correspondence Address: William E. Vaughan, Bell, Boyd & Lloyd LLC, P.O. Box 1135, Chicago, IL, 60690-1135, US

(21) Appl. No.: 09/491,611

(22) Filed: Jan. 26, 2000

(30) Foreign Application Priority Data
Jan. 26, 1999 (DE) 19903004.9

(51) Int. Cl. H01Q 1/24; H01Q 21/00

(52) U.S. Cl. 343/700 MS; 343/702

(57) ABSTRACT

The present invention is directed to an antenna for radio-operated communication terminal devices. For effecting a multi-band antenna, a combination composed of a number of different antenna types is provided, wherein each antenna type can be singly or multiply present, and wherein the combination of the number of antennas is respectively fed at only one point.

### BACKGROUND OF THE INVENTION

1. Field of the Invention

The present invention is directed, generally, to an antenna for radio-operated communication terminal equipment and, more specifically, to an antenna made up of a number of different antenna types for covering a number of different frequency bands.

2. Description of the Prior Art

Particularly in view of developments in mobile radio telephone technology, antennas are required to simultaneously cover a number of frequency bands. Moreover, the marketplace is demanding both smaller and cheaper mobile ratio telephone devices. Antennas are therefore required that have a low space requirement, that can be unproblemmatically designed to function in either a plurality of frequency bands or a broadband frequency range and that can be inexpensively manufactured.

Solutions are known in this field wherein two or more individual planar inverted-F antennas are simply integrated in a piece of communication terminal equipment. However, one or more feed points are then required which need to be driven via suitable circuitry; thus, representing an additional outlay.

An object of the present invention, therefore, is to specify an antenna for radio-operated communication terminal equipment that is simply constructed and can simultaneously cover a plurality of frequency bands.

### SUMMARY OF THE INVENTION

An antenna for radio-operated communication terminal equipment for achieving the above-mentioned object is characterized by a combination of different antenna types, wherein each antenna type can be singly or multiply present, and wherein the combination composed of a plurality of antennas is respectively supplied at only one point.

The inventive antenna is easy and inexpensive to manufacture, has a small space requirement and can be unproblemmatically designed to function in either a plurality of frequency bands or a broadband frequency range.

Additional features and advantages of the present invention are described in, and will be apparent from, the Detailed Description of the Preferred Embodiments and the Drawings.

### DESCRIPTION OF THE DRAWINGS

FIG. 1 shows a perspective, schematic view of an embodiment of an antenna according to the present invention composed of both a planar inverted-F antenna and a patch antenna.

FIG. 2 shows a perspective, schematic view of another embodiment of an antenna according to the present invention composed of both a planar inverted-F antenna and a planar inverted-L antenna.

FIG. 3 shows a perspective, schematic view of a further embodiment of an antenna according to the present invention composed of both a patch antenna and a planar inverted-L antenna.

FIG. 4 shows a perspective, schematic view of yet another embodiment of an antenna according to the present invention having a defined, separate ground plate.

FIGS. 5A through 5M show examples of different embodiments of the radiator elements of further embodiments of an antenna of the present invention;

FIG. 6 shows a schematic sectional view of a shortened antenna of the present invention.

FIG. 7 shows a schematic sectional view of an alternative shortened antenna of the present invention.

FIG. 8 shows a schematic sectional view of yet another shortened antenna in accordance with the present invention.

FIGS. 9 through 11 show schematic arrangements of inventive antennas for improving emission properties; and

FIG. 12 shows a perspective, schematic view of a further possible embodiment of an antenna according to the present invention.

### DETAILED DESCRIPTION OF THE PREFERRED EMBODIMENTS

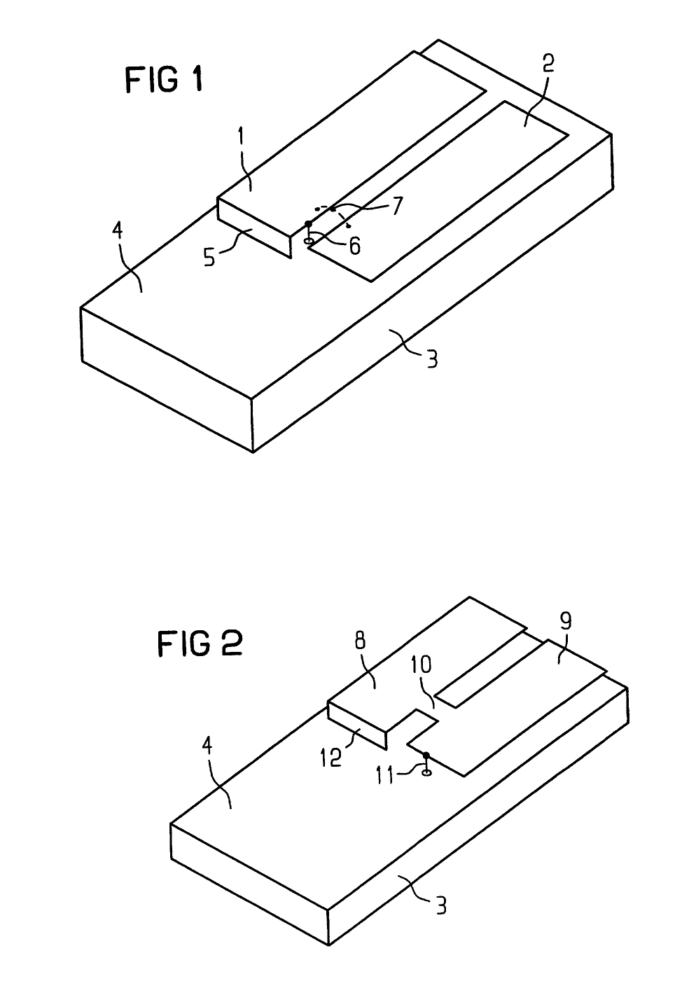

In FIG. 1, reference numerals 1 and 2 refer to the two actual antennas from which the inventive multi-band antenna is composed. In this example, the antennas include a planar inverted-F antenna 1 and a patch antenna or microstrip antenna 2. Only part of the housing wall of the mobile radio telephone apparatus 3 is shown, this part being covered with a metallic EMC shielding 4. Given the illustrated multi-band antenna, this metallic EMC shielding forms a ground needed for the two antennas 1 and 2.

The connection between the radiator element of the antenna 1 and the metallic EMC shielding 4 is produced via the ground connection 5. The actual feed point of the antenna is referenced 6. 7 indicates a symbolic coupling of the two antennas 1 and 2. This coupling can be capacitative, inductive, radiated or galvanic. Various parameters of the antenna can be set given the nature of the coupling. With respect to the antenna configuration shown in FIG. 1, the ground connection 5 may be punctiform as well as multiply punctiform.

FIG. 2 shows a perspective, schematic view of a multi-band antenna according to the present invention that is composed of a planar inverted-F antenna 8 and a planar inverted-L antenna 9. In the present case, the two antennas 8 and 9 are coupled to one another via a galvanic coupling 10. The feed of the multi-band antenna occurs via a feed point 11 that is connected to the planar inverted-L antenna 9. The ground connection of the illustrated antenna configuration occurs via the ground connection 12.

FIG. 3 shows an antenna configuration that is composed of a microstrip antenna 13 and a planar inverted-L antenna 14 galvanically connected thereto. The antenna configuration is fed via the feed point 15.

FIG. 4 shows an exemplary embodiment of an inventive multi-band antenna that, in contrast to the multi-band antenna shown in FIG. 1, has an additional, separate ground plate 16. Since the ground conditions within a piece of radio-operated communication terminal equipment cannot always be fully estimated under normal circumstances, the ground plate 16 sees to define ground relationships with reference to the multi-band antenna. One or more connections can be provided between the ground plate and the apparatus ground.

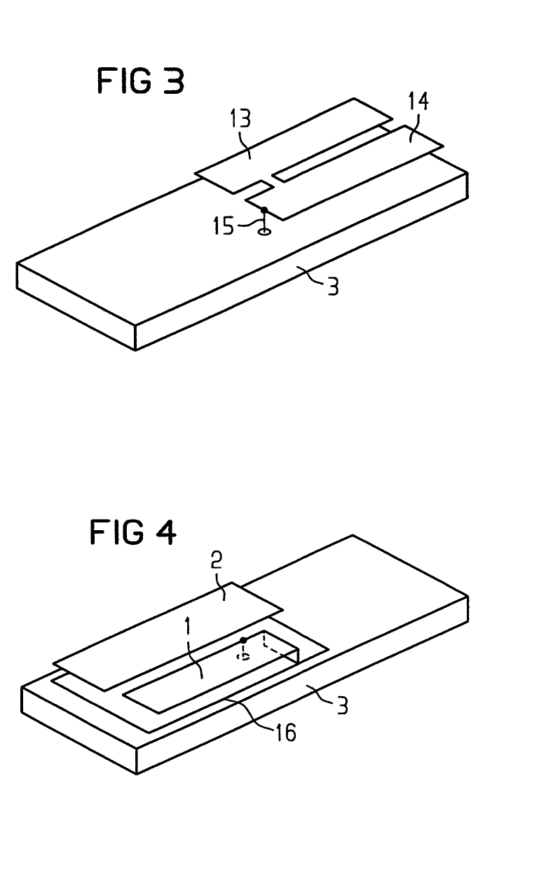

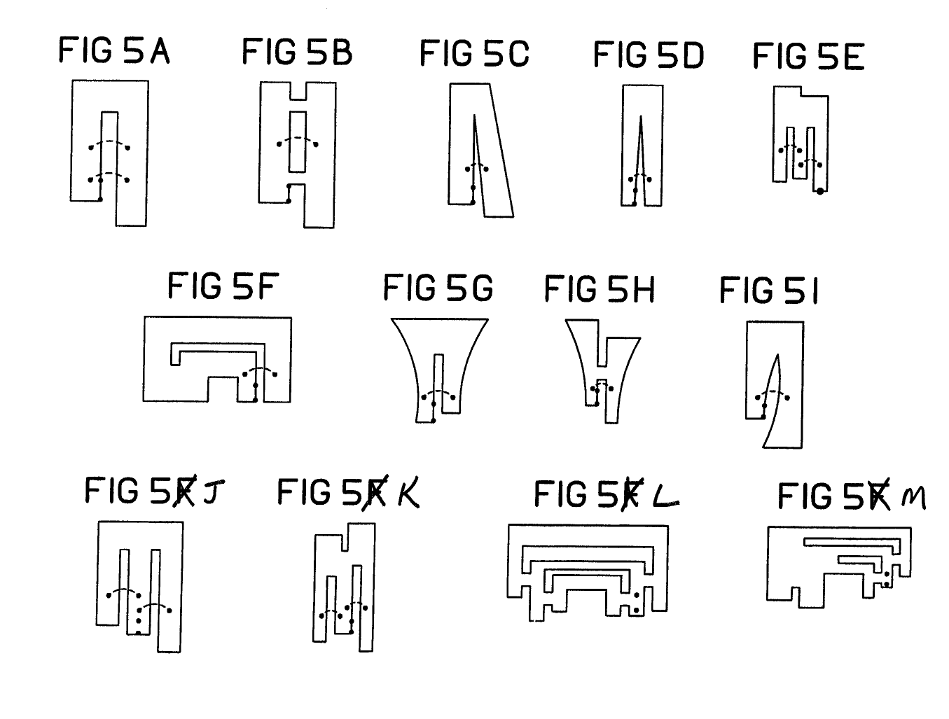

FIGS. 5A through 5M show a small, exemplary selection of differently configured antenna types coupled to one another in conformity with the present invention. This selection is in no way limiting. It is also true here that the combination of the antenna types coupled to one another can be arbitrary.

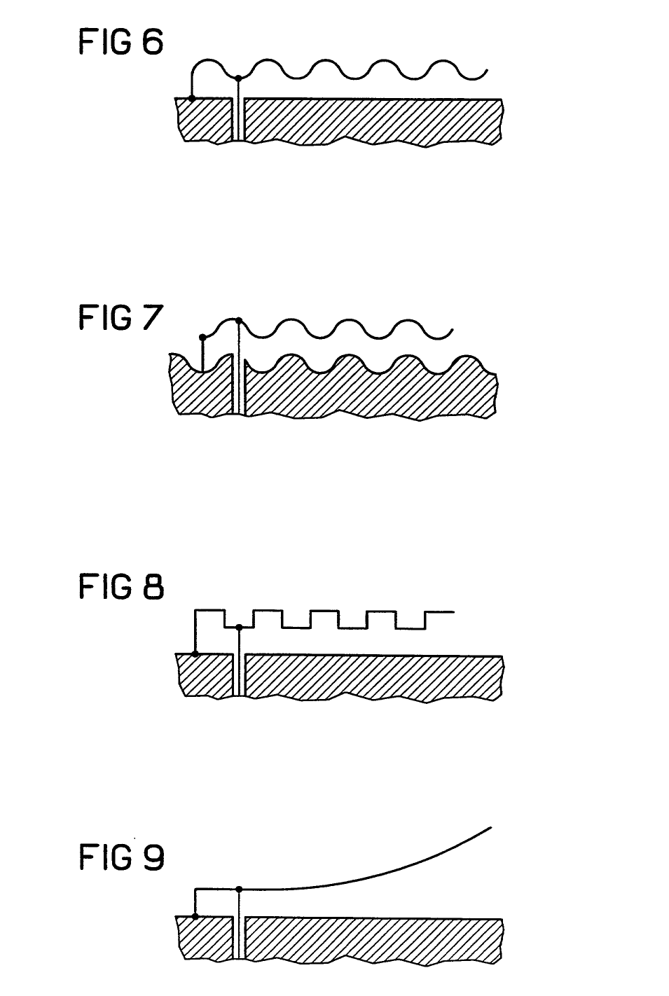

For shortening the structural length of the inventive antenna, the radiator element can be configured in a wave-shape, as shown in FIG. 6, or can be configured rectangularly, as shown in FIG. 8.

It is shown by way of example in FIG. 7 that, of course, the ground plate also can adapt to the shape of the radiator element.

It can be provided, for improving emission properties and increasing bandwidth, that the plane of the radiator element of the multi-band antenna not proceed 100% parallel to the metallic EMC shielding of the radio-operated communication terminal device. Rather, a greater distance between the antenna and the metallic EMC layer forms at one or more locations. This is shown by way of example in FIG. 9. The increase in distance also can occur, for example, at the feed point of the antenna.

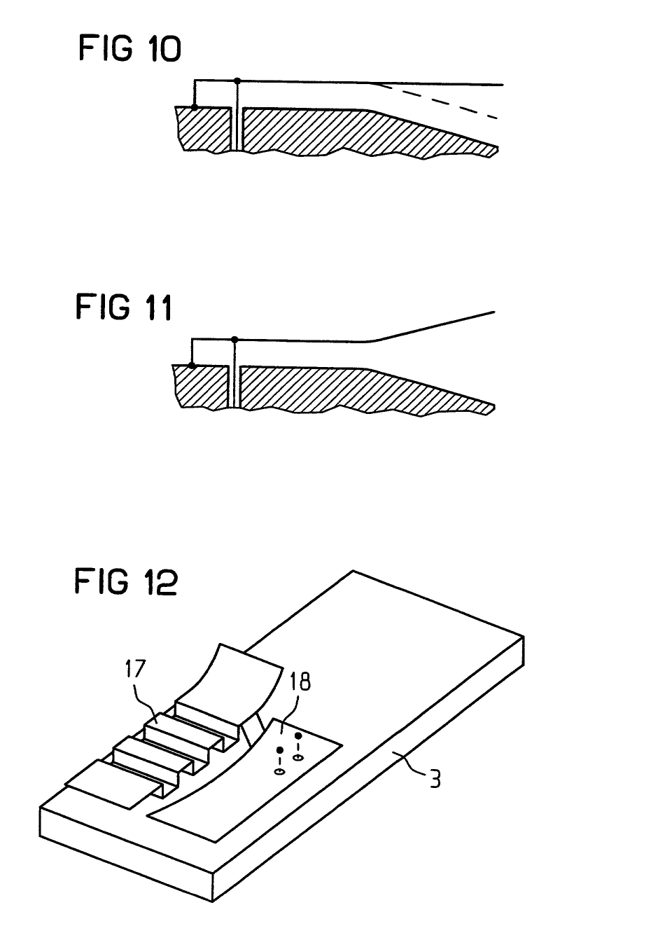

The same problem is shown in FIG. 10, wherein it is assumed that the plane of the radiator element of the multi-band antenna adapts to the course of the housing (shown with broken lines in FIG. 10) but can be continued on a straight line in order to improve emission properties. Another possibility for improving emission properties of the antenna is schematically shown in FIG. 11.

FIG. 12 shows a perspective, schematic view of a partially shortened antenna configuration according to the present invention. The illustrated antenna configuration is composed of an upset microstrip antenna 17 and a planar inverted-F antenna 18 that are galvanically connected to one another, wherein the feed and the connection to ground occur via the planar inverted-F antenna. At the same time, parts of the actual radiator elements of the two antennas exhibit different heights or, respectively, slopes.

It is to be emphasized that the inventive antenna solves the problem underlying the invention that no one or more planar inverted-F antennas and/or no one or more planar inverted-L antennas and no one or more microstrip (patch) antennas are connected to one another to form an antenna system by coupling. Only antenna systems composed of two different antennas are shown in the exemplary embodiments presented above. However, the present invention should not be limited thereto.

The antenna structure is fed at only one point. This preferably has a planar inverted-F structure or a planar inverted-L structure. However, the present invention also contemplates a feed which occurs via a microstrip structure. The coupling between the individual radiator elements thereby can be capacitative, inductive, radiated or galvanic. Various parameters of the antenna can be set by the nature and plurality of the couplings. When, for example, the dimensions for the planar inverted-F antenna and the microstrip antenna are approximately the same in terms of length, the radiation frequencies behave at a ratio of approximately 1:2. This can be utilized given employment as a GSM-PCN antenna.

As a result of a suitable design of the combination of radiator elements, a part thereof can be used for two or more frequency ranges and, as a result, the overall dimensions of the antenna system can be kept small. Additional emissions at further frequencies can occur due to cross-resonances between the various radiator parts.

This planar antenna structure requires one feed connection and one or more ground connections that can be arbitrarily shaped in order to set specific antenna properties. The connection points for the feed and connection to ground indicated in the drawings can be interchanged as well and need not necessarily lie at either the edge or a corner of the radiator structure. Such connection points can be positioned such that a desired impedance behavior occurs for all operating frequency ranges.

The antenna either can have its own ground plate or can use the metallic parts and services of the radio-operated communication terminal device as ground plate. The potentially additional ground plate thereby can be arbitrarily shaped and need not necessarily be matched to the shape of the radiator element.

The individual parts of the radiator element can exhibit different heights compared to the ground surface, for example, by crimping or slopes. For reducing the dimensions in longitudinal direction, the antenna also can be upset on the basis of a suitable vertical structuring or can be shortened by a suitable folding. The type of folding and/or upsetting thereby can be arbitrarily implemented and accomplished in various technologies. Thus, only the radiator element or, on the other hand, the appertaining ground surface can be correspondingly structured. The corresponding shaping of the individual radiator elements can further modify or improve the emission properties or adapt the antenna to the geometry of the housing. For example, graduation, slots, tapering, modification of the radiator height over the ground surface may be incorporated in this case.

For mechanical reasons or, respectively, for improving the emission properties or for optimum utilization of an available volume, it is likewise possible to introduce suitable dielectric or magnetic materials into the antenna structure. These can partially or completely fill the antenna structure. Combinations of various dielectric and/or magnetic substances or, respectively, air are also possible.

The advantage of the inventive multi-band antenna is that individual radiator parts that are used, for example, for a planar inverted-F antenna also can be utilized for emission as an inverted-L antenna or a microstrip antenna. Arbitrary combinations of radiator elements are thereby possible which, consequently, make possible additional deriving antenna structures. These enable an emission in further frequency ranges or can be utilized for further improvement of one or more emission behaviors. Due to the multiple possibilities of radiator parts utilization, the area requirement or, respectively, volume requirement can be kept low. Since an impedance of, for example, 50 ohms can be set for all frequency ranges at the single foot point (i.e., the feed point) of the antenna, no further wiring is required. The losses in a feed network that is otherwise potentially required are thus eliminated. Since, dependent on the frequency range, different parts contribute to the radiation given the inventive antennas, not all frequency ranges are identically disturbed given an inadvertent, partial covering of the antenna with the hand. Consequently, an existing voice connection can be potentially maintained in an undisturbed frequency range.

Although the present invention has been described with reference to specific embodiments, those of skill in the art will recognize that changes may be made thereto without departing from the spirit and scope of the invention as set forth in the hereafter appended claims.

I claim as my invention:

1. An antenna for radio-operated communication terminal devices, comprising a combination of individual antennas composed of a plurality of different antenna types, wherein each of the plurality of different antenna types can be singly or multiply present, and wherein the combination of individual antennas is respectively fed at only one point at a feed connection.

2. An antenna for radio-operated communication terminal devices as claimed claim 1, wherein the plurality of different antenna types includes at least two of inverted-F antennas, planar inverted-L antennas and microstrip antennas.

3. An antenna for radio-operated communication terminal devices as claimed in claim 1, wherein a coupling between the plurality of different antenna types occurs by at least one of capacitively, inductively, radiated or galvanically.

4. An antenna for radio-operated communication terminal devices as claimed in claim 1, wherein the antenna is integrated into a housing wall of a housing of the associated terminal device.

5. An antenna for radio-operated communication terminal devices as claimed in claim 1, wherein a position and a type of at least one ground connection between a radiator element of the antenna and a ground surface of the antenna is adapted to desired antenna properties.

6. An antenna for radio-operated communication terminal devices as claimed in claim 1, wherein a position and a type of the feed connection to a radiator element of the antenna is adapted to desired antenna properties.

7. An antenna for radio-operated communication terminal devices as claimed in claim 1, wherein a position and a type of at least one ground connection between a defined, separate ground surface and a ground surface of the antenna are adapted to desired antenna properties.

8. An antenna for radio-operated communication terminal devices as claimed in claim 1, wherein a position of the feed connection and a position of ground connections to an effective antenna ground are interchanged.

9. An antenna for radio-operated communication terminal devices as claimed in claim 1, wherein the feed connection and ground connections contact a radio element at arbitrary positions.

10. An antenna for radio-operated communication terminal devices as claimed in claim 1, wherein the feed connection and ground connections are arbitrarily shaped.

11. An antenna for radio-operated communication terminal devices as claimed in claim 1, wherein individual parts of radiator elements of the antenna are shaped so as to point in arbitrary directions.

12. An antenna for radio-operated communication terminal devices as claimed in claim 1, wherein a radiator structure of the antenna is divided into a plurality of sub-elements which meet a desired antenna function by suitable coupling.

13. An antenna for radio-operated communication terminal devices as claimed in claim 1, wherein individual parts of radiator elements of the antenna are arbitrarily curved or folded in a horizontal plane.

14. An antenna for radio-operated communication terminal devices as claimed in claim 1, wherein a desired antenna behavior is achieved by at least partial introduction of at least one of one or more dielectric materials, one or more magnetic materials and a mixture of dielectric and magnetic materials.

15. An antenna for radio-operated communication terminal devices as claimed in claim 1, wherein sub-areas of the antenna are utilized for antenna functions in different frequency ranges.
